(19) United States
(12) Patent Application Publication
(10) Pub. No.: US 2012/0226781 A1
(43) Pub. Date: Sep. 6, 2012

(54) MULTIMEDIA DATA STREAMING SYSTEM AND METHOD

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/291,161

(22) Filed: Nov. 8, 2011

(30) Foreign Application Priority Data
Mar. 1, 2011 (TW) 100106578

(51) Int. Cl. G06F 15/16

(52) U.S. Cl. 709/219

(57) ABSTRACT

A multimedia data streaming system and method are disclosed. The multimedia data streaming method comprises establishing communications between a streaming gateway and a multimedia server, and communications between the streaming gateway and a client device; sending identification information to the multimedia server; downloading a multimedia file from the multimedia server, wherein the multimedia file is authorized in relation to the identification information; storing the multimedia file in a storage area of the streaming gateway, wherein the storage area is not accessible to the client device; producing a plurality of multimedia streams based on the multimedia file; opening a specified port of the streaming gateway to the client device; and transmitting the plurality of multimedia streams to the client device through the specified port.

### BACKGROUND

1. Technical Field

The disclosure generally relates to a system and a method for providing multimedia data.

2. Description of Related Art

Music may be purchased through an online music store such as iTunes® or eMusic®. After a purchase, a user may download an authorized music file in a variety of formats, such as MP3, WMA and AAC, from the online music store. Currently, when the user is authorized to obtain a particular music file from the online music store, the uniform resource locator (URL) for that file may be delivered to the user. While most users may not ordinarily notice the URL, sophisticated Internet users may readily see the URL using tools available in most Internet browser applications. An unscrupulous user may then guess the locations of the other music files in the online music store. The unscrupulous user could then access these locations to obtain the music files without authorization and without paying any fees for the music files. Such activities may deprive the online music store of revenue generating opportunities. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of a streaming gateway suitable for use in implementing a streaming providing system according to one embodiment of the present disclosure.

FIG. 2 is a schematic diagram the streaming gateway of FIG. 1 may operate in a networked environment.

FIG. 3 is a schematic diagram of the function modules of a streaming providing system according to one embodiment of the present disclosure.

FIG. 4 is an operational flow chart of providing multimedia data using the streaming gateway of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

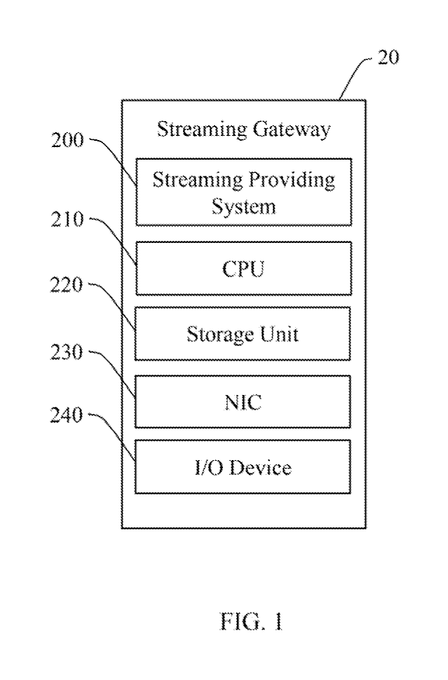

Referring to FIG. 1, a streaming gateway 20 is shown. The streaming gateway 20 may be constructed on a desktop, a laptop, or on a server grade hardware platform such as an x86 or an x64 architecture platform. Such a hardware platform may include a central processing unit (CPU) 210, a storage unit 220, a network interface controller (NIC) 230 (also referred to herein as a network card), and other Input/Output (I/O) devices 240. The streaming gateway 20 implements the functions of a streaming providing system 200.

The storage unit 220 may be any form of volatile or non-volatile storage, including, for example, RAM, ROM, EPROM, flash memory, a magnetic disk such as an internal hard disk or a removable disk, an optical disk such as a CD-ROM, or any other storage which can be used to store the information, and can be accessed by the streaming gateway 20. The storage unit 220 may store machine-executable instructions, data, and various programs, such as an operating system and one or more application programs, all of which may be processed by the CPU 210.

The streaming gateway 20 may comprise one or more I/O devices 240 such as a display, a keyboard, a mouse, or other pointing device. The storage unit 220, the NIC 230 and the other I/O devices 240 are connected to the CPU 210 through a system bus (not shown in FIG. 1).

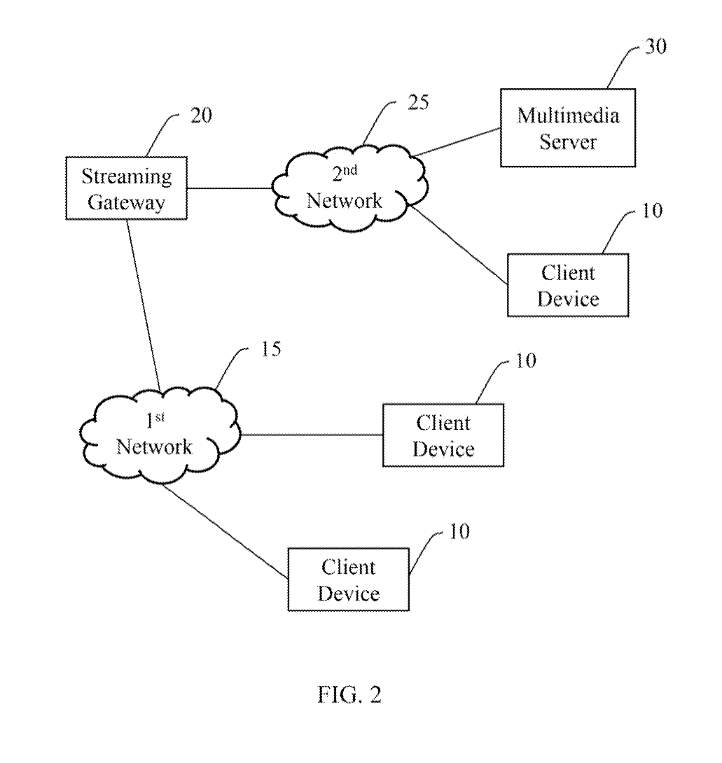

With reference to FIG. 2, the streaming gateway 20 can operate in a first network 15 and a second network 25. The first network 15 and the second network 25 provide logical connections to one or more remote computers, such as one or more client devices 10 and a multimedia server 30. The first network 15 and the second network 25 can be either a local area network (LAN) or a wide area network (WAN), such as the Internet. The streaming gateway 20 is connected into the first network 15 and the second network 25 through the NIC 230. The NIC 230 may be a network interface card using a specific physical layer and a data link layer standard such as Ethernet or Wi-Fi. If used in a WAN networking environment, the streaming gateway 20 may typically include a modem or other means for establishing communications over the WAN, such as the Internet.

The multimedia server 30 can store a plurality of multimedia files, such as video, audio, and image files. The streaming gateway 20 can be in communication with the multimedia server 30 through the second network 25. The multimedia server 30 may be provided by an online digital multimedia store.

The one or more client devices 10 may be a user end-point for playing multimedia data provided by the streaming gateway 20. The one or more client devices 10 can be located either in the first network 15 or in the second network 25, in which the multimedia server 30 is located. In other words, the one or more client devices 10 can share a same networked environment as the multimedia server 30, or may be in an independent networked environment. The one or more client devices 10 can be personal computers, media players, smart phones or the like.

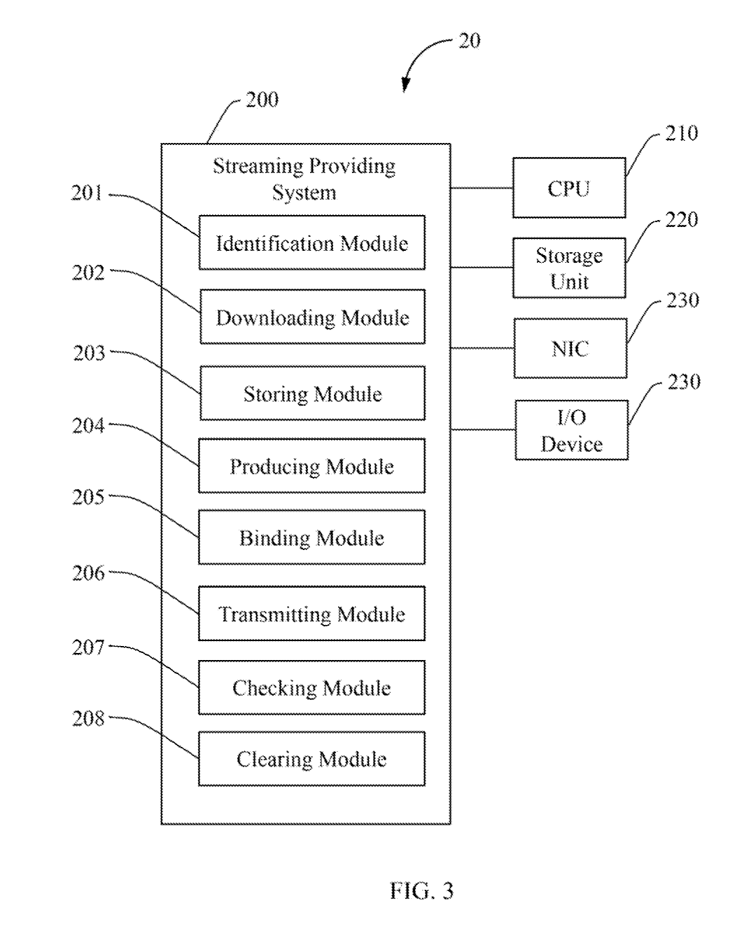

FIG. 3 illustrates a schematic diagram of the function modules of the streaming providing system 200. In one embodiment, the streaming providing system 200 can comprise an identification module 201, a downloading module 202, a storing module 203, a producing module 204, a binding module 205, a transmitting module 206, a checking module 207 and a clearing module 208. Each of the modules 201-208 can be a software program including one or more computerized instructions stored in the storage unit 220 and can be executed by the CPU 210.

When the one or more client devices make requests for the multimedia files, the identification module 201 can receive identification information from the one or more client devices 10. The identification information can include, at least, a user name, a password and an email address for identifying a target registered user of the multimedia server 30. The identification module 201 can send the identification information to the multimedia server 30.

When the multimedia server 30 receives the identification information from the identification module 201, the multimedia server 30 can determine one or more multimedia files (“authorized multimedia files”) which are authorized in relation to the identification information. The multimedia server 30 can transmit a listing of the authorized multimedia files to the streaming gateway 20.

The downloading module 202 can download the authorized multimedia files from the multimedia server 30 according to the listing of the authorized multimedia files. The storing module 203 can store the downloaded authorized multimedia files in a storage area of the storage unit 220. The storage area is not accessible to the one or more client devices 10. In this way, the one or more client devices 10 can not able to access the storage area and obtain any multimedia files from the storage area.

The producing module 204 can split a multimedia file into a plurality of data blocks and convert the plurality of data blocks into multimedia streams in a streaming format compatible with the one or more client devices 10. The streaming format can be Real Audio (RA), Real Media (RM), QuickTime (MOV), Windows Media Audio (WMA), Advanced Streaming Format (ASF), or other similar formats. When one of the pluralities of data blocks has been converted to a multimedia stream, the producing module 204 can delete the data blocks from the plurality of data blocks. In other embodiments, the block size can be predefined by an XML file, which is stored in the storage unit 220. The producing module 204 can split the multimedia file into a plurality of data blocks according to the predefined block size.

The binding module 205 can open a specified port of the streaming gateway 20 to the one or more client devices 10. The transmitting module 206 can transmit the multimedia streams to the one or more client devices 10 through the specified port in a streaming protocol compatible with the one or more client devices 10. The streaming protocol can be Real-time Transport Protocol (RTP), Microsoft Media Server (MMS) protocol, or Real Time Streaming Protocol (RTSP). The one or more client devices 10 can passively receive the multimedia streams from the streaming gateway 20 through the specified port. Although the one or more client devices 10 can play the multimedia streams, the one or more client devices 10 cannot access the streaming gateway 20 to obtain any multimedia stream or file.

In one embodiment, each authorized multimedia file is associated with an expiration time. The checking module 207 can check whether an authorized multimedia file has expired. When the authorized multimedia file has expired, the checking module 207 can delete the authorized multimedia file from the storage area of the storage unit 220.

In another embodiment, each authorized multimedia file is associated with an creation time, which records the time when the authorized multimedia file is downloaded and stored in the streaming gateway 20. The clearing module 208 can check whether a usage rate of the storage area has reached a predefined threshold, such as 80 percent. The clearing module 208 can determine the oldest authorized multimedia files among all of the authorized multimedia files by comparing the creation time of each and all of the authorized multimedia files in the storage area. When the usage rate of the storage area has reached the predefined threshold, the clearing module 208 can delete the oldest authorized multimedia files according to their creation times to lower the usage rate of the storage area.

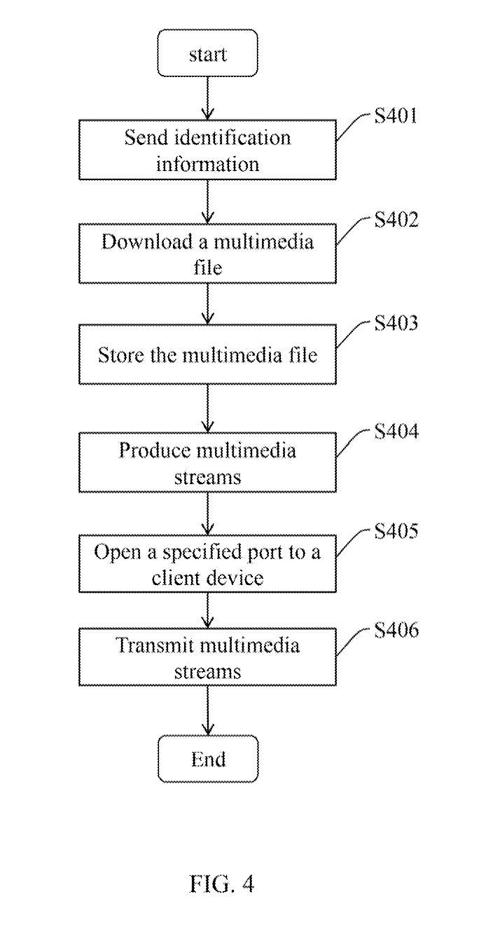

FIG. 4 is a flowchart of providing multimedia data using the streaming gateway 20 according to one embodiment. The method can comprise the following steps:

In step S401, the identification module 201 sends identification information to the multimedia server 30. The identification information can be used for identifying and authorizing a target registered user of the multimedia server 30.

In step S402, the downloading module 202 downloads an authorized multimedia file from the multimedia server 30. The authorized multimedia file can be determined by the multimedia server 30 according to the identification information.

In step S403, the storing module 203 stores the downloaded multimedia file in a storage area of the storage unit 220 which is not accessible to the one or more client devices 10.

In step S404, the producing module 204 splits the authorized multimedia file into a plurality of data blocks and convert the plurality of data blocks into multimedia streams in a streaming format, which is compatible with the one or more client devices 10.

In step S405, the binding module 205 opens a specified port of the streaming gateway 20 to the one or more client devices 10.

In step S406, the transmitting module 206 transmits the multimedia streams to the one or more client device 10 through the specified port in a streaming protocol, which is compatible with the one or more client device 10.

Even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. Although the descriptions and the claims drawn for or in relation to a method may include some indication in reference to certain steps, any indication used is only to be viewed for identification purposes and not as a suggestion as to an order for the steps.

What is claimed is:

1. A multimedia data streaming method comprising:
establishing communications between a streaming gateway and a multimedia server, and communications between the streaming gateway and a client device;
sending identification information to the multimedia server;
downloading a multimedia file from the multimedia server, wherein the multimedia file is authorized in relation to the identification information;
storing the multimedia file in a storage area of the streaming gateway, wherein the storage area is not accessible to the client device;
producing a plurality of multimedia streams based on the multimedia file;
opening a specified port of the streaming gateway to the client device; and
transmitting the plurality of multimedia streams to the client device through the specified port.

2. The multimedia data streaming method of claim 1 further comprising:
associating the multimedia file with an expiration time; and
deleting the multimedia file from the storage area when the multimedia file is older than the expiration time.

3. The multimedia data streaming method of claim 1 further comprising:
associating each of the multimedia files with a creation time when the multimedia files are stored in the storage area; and
if a usage rate of the storage area reaches a predefined threshold, determining an oldest multimedia file by comparing the creation time of each of the multimedia files in the storage area, and deleting the oldest multimedia file from the storage area.

4. The multimedia data streaming method of claim 1, the producing further comprises:
splitting the multimedia file into a plurality of data blocks; and
converting the plurality of data blocks into the plurality of multimedia streams.

5. The multimedia data streaming method of claim 4, the producing further comprises deleting one of the plurality of data blocks when the one of the plurality of data blocks has been converted to one of the plurality of multimedia streams.

6. The multimedia data streaming method of claim 4, the splitting further comprises splitting the multimedia file into the plurality of data blocks according to a predefined block size.

7. The multimedia data streaming method of claim 1, the transmitting further comprises transmitting the plurality of multimedia streams to the client device through the specified port one after another.

8. The multimedia data streaming method of claim 1, further comprising converting the plurality of multimedia streams into a steaming format compatible with the client device.

9. The multimedia data streaming method of claim 1, the transmitting comprises transmitting the plurality of multimedia streams to the client device in a streaming protocol compatible with the client device.

10. A multimedia data streaming gateway, the multimedia data streaming gateway being in communication with a multimedia server and a client device, the multimedia data streaming gateway comprising:
an identification module adapted to send identification information to the multimedia server;
a downloading module adapted to download a multimedia file from the multimedia server, wherein the multimedia file is authorized in relation to the identification information;
a storing module adapted to store the multimedia file in a storage area of the streaming gateway, wherein the storage area is not accessible to the client device;
a producing module adapted to produce a plurality of multimedia streams based on the multimedia file;
a binding module adapted to open a specified port of the streaming gateway to the client device; and
a transmitting module adapted to transmit the plurality of multimedia streams to the client device through the specified port.

11. The multimedia data streaming gateway of claim 10, wherein the multimedia file is associated with an expiration time, the multimedia data streaming gateway further comprises a checking module adapted to determine whether the multimedia file is older than the expiration time and delete the multimedia file from the storage area when the multimedia file is older than the expiration time.

12. The multimedia data streaming gateway of claim 10, wherein each of the multimedia files is associated with a creation time recording the time when the multimedia files are stored in the storage area, the multimedia data streaming gateway further comprises a clearing module adapted to delete the multimedia file when a usage rate of the storage area reaches a predefined threshold and the multimedia file is the oldest file among all files in the storage area according the creation time of the multimedia file.

13. The multimedia data streaming gateway of claim 12, wherein the clearing module is adapted to determine an oldest multimedia file among all files in the storage area by comparing the creation time of the multimedia file to creation times of all files in the storage area.

14. The multimedia data streaming gateway of claim 10, the producing module is adapted to split the multimedia file into a plurality of data blocks and convert the plurality of data blocks into the plurality of multimedia streams.

15. The multimedia data streaming gateway of claim 14, the producing module is further adapted to delete a block of the plurality of data blocks when the block of the plurality of data blocks has been converted to the plurality of multimedia streams.

16. The multimedia data streaming gateway of claim 14, the producing module is further adapted to split the multimedia file into the plurality of data blocks according to a predefined block size.

17. The multimedia data streaming gateway of claim 10, the transmitting module is adapted to transmit the plurality of multimedia streams to the client device through the specified port one after another.

18. The multimedia data streaming gateway of claim 10, the producing module is adapted to convert the plurality of multimedia streams into a steaming format compatible with the client device.

19. The multimedia data streaming gateway of claim 10, the transmitting module is adapted to transmit the plurality of multimedia streams to the client device in a streaming protocol compatible with the client device.

20. A multimedia data streaming method comprising:
establishing communications between a streaming gateway and a multimedia server, and communications between the streaming gateway and a client device;
providing an identification module, a downloading module, a storing module, a producing module, a binding module, and a transmitting module;
sending identification information to the multimedia server by the identification module;
downloading a multimedia file from the multimedia server by the downloading module, wherein the multimedia file is authorized in relation to the identification information;
storing the multimedia file in a storage area of the streaming gateway by the storing module, wherein the storage area is not accessible to the client device;
producing a plurality of multimedia streams based on the multimedia file by the producing module;
opening a specified port of the streaming gateway to the client device by the binding module; and
transmitting the plurality of multimedia streams to the client device through the specified port by the transmitting module.
